(19) United States
(12) Patent Application Publication
(10) Pub. No.: US 2025/0035121 A1
(43) Pub. Date: Jan. 30, 2025

(54) TURBOMOLECULAR PUMP BLADED DISC

(71) Applicant: Edwards Limited, Burgess Hill, Sussex (GB)

(72) Inventor: Nicolas Jonathan Grant, Burgess Hill, Sussex (GB)

(21) Appl. No.: 18/708,873

(22) PCT Filed: Nov. 9, 2022
(86) PCT No.: PCT/GB2022/052826

§ 371 Date: May 9, 2024

(30) Foreign Application Priority Data
Nov. 10, 2021 (GB) 2116144.3

(51) Int. Cl. F04D 19/04; F04D 29/32

(52) U.S. Cl. CPC F04D 19/042; F04D 29/324

(57) ABSTRACT

A turbomolecular pump bladed disc, comprising: a central hub configured to be rotated about an axis, the axis defining an axial direction; and one or more blades radially extending from the central hub; wherein each of the one or more blades has a cross-section that: tapers to a first point in a first direction, the first direction being parallel with the axial direction, tapers to a second point in a second direction, the second direction being parallel with the axial direction and opposite to the first direction; and is substantially a parallelogram in shape.

### CROSS-REFERENCE OF RELATED APPLICATION

This application is a Section 371 National Stage Application of International Application No. PCT/GB2022/052826, filed Nov. 9, 2022, and published as WO 2023/084200A1 on May 19, 2023, the content of which is hereby incorporated by reference in its entirety and which claims priority of British Application No. 2116144.3, filed Nov. 10, 2021.

### FIELD

The present invention relates to turbomolecular pumps (TMPs) and bladed discs, such as rotor discs and stator discs, therefor.

### BACKGROUND

A turbomolecular pump is a type of vacuum pump which operates by pushing gas molecules in a desired pumping direction using rotating blades in one or more bladed pumping stages.

Turbomolecular pumps typically comprise a plurality of rotating and stationary discs following each other and spaced apart from one another in the axial direction of the pump. The rotating discs are referred to as rotor discs, the stationary ones as stator discs. Both discs are so shaped that they form blades at the disc periphery. Hence the discs may be referred to as bladed discs. The bladed discs are formed such that passages are present between adjacent blades. The blades of rotor discs subtend acute angles with the direction of rotation, whereas the blades of the stator discs subtend obtuse angles with the direction of rotation of the rotor discs.

The discussion above is merely provided for general background information and is not intended to be used as an aid in determining the scope of the claimed subject matter. The claimed subject matter is not limited to implementations that solve any or all disadvantages noted in the background.

### SUMMARY OF INVENTION

In an aspect, there is provided a turbomolecular pump bladed disc, comprising: a central hub configured to be rotated about an axis, the axis defining an axial direction; and one or more blades radially extending from the central hub. Each of the one or more blades has a cross-section that tapers inwardly in a first direction, the first direction being parallel with the axial direction.

Each of the one or more blades may have a cross-section whose width decreases along the first direction. The width may be defined in a direction that is perpendicular to the first direction in a plane of the cross-section.

For each of the one or more blades, the cross-section of that blade may taper to a point in the first direction. For each of the one or more blades, the point to which the cross-section of that blade tapers in the first direction may be a furthest point in the first direction.

For each of the one or more blades, the cross-section of that blade may taper (e.g. inwardly) in a second direction, the second direction being parallel with the axial direction and opposite to the first direction. For each of the one or more blades, the cross-section of that blade may taper to a point in the second direction. For each of the one or more blades, the point to which the cross-section of that blade tapers in the second direction may be a furthest point in the second direction.

For each of the one or more blades, a shape of the cross-section of that blade may be substantially that of a parallelogram, a trapezium, or a pentagon.

For each of the one or more blades, the cross-section of that blade may be an intersection of that blade with a plane perpendicular to a radial direction in which that blade extends from the central hub.

For each of the one or more blades, the cross-section of that blade may be at or proximate to a tip of that blade.

For each of the one or more blades, the cross-section may taper inwardly in the first direction along at least a majority of a length of the blade. The length of the blade may be defined in a direction radially outward from the central hub.

For each of the one or more blades, the cross-section may taper inwardly in the first direction along an entirety of the length of the blade.

The cross-section may be defined by a plurality of sides, all of said plurality of sides being oblique or parallel to the axial direction.

For each of the one or more blades, the cross-section may be defined by a plurality of sides, one or more of the plurality of sides being perpendicular to both the axial and radial directions and less or equal to 20% of a thickness of a blade and/or less than or equal to 5 mm.

In a further aspect, there is provided a turbomolecular pump comprising one or more turbomolecular pump bladed discs, the one or more turbomolecular pump bladed discs being in accordance with any of the preceding aspects.

The one or more turbomolecular pump bladed discs may be rotor discs or stator discs.

In a further aspect, there is provided a method of manufacturing a turbomolecular pump bladed disc. The turbomolecular pump bladed disc is in accordance with any preceding aspect. The method comprises providing a disc (e.g., a bladed disc), and machining the disc to produce the turbomolecular pump bladed disc.

In a further aspect, there is provided a turbomolecular pump bladed disc, comprising a central hub configured to be rotated about an axis, the axis defining an axial direction, and one or more blades radially extending from the central hub. Each of the one or more blades has a cross-section that: tapers to a first point in a first direction, the first direction being parallel with the axial direction; tapers to a second point in a second direction, the second direction being parallel with the axial direction and opposite to the first direction; and is substantially a parallelogram in shape.

For each of the one or more blades, the cross-section of that blade may be an intersection of that blade with a plane perpendicular to a radial direction in which that blade extends from the central hub.

For each of the one or more blades, the cross-section of that blade may be at or proximate to a tip of that blade.

For each of the one or more blades, the cross-section may taper to a point in the first direction along at least a majority of a length of the blade, the length of the blade being defined in a direction radially outward from the central hub. For each of the one or more blades, the cross-section may taper to a point in the first direction along an entirety of the length of the blade. For each of the one or more blades, the cross-section may taper to a point in the second direction along at least a majority of a length of the blade, the length of the blade being defined in a direction radially outward from the central hub. For each of the one or more blades, the cross-section may taper to a point in the second direction along an entirety of the length of the blade.

For each of the one or more blades, the first point may be a furthest point on the blade in the first direction. For each of the one or more blades, the second point may be a furthest point on the blade in the second direction.

For each of the one or more blades, the (parallelogram) cross-section may be defined by a plurality of sides, all of said plurality of sides being oblique or parallel to the axial direction. Preferably, the sides of the parallelogram are oblique (i.e., neither parallel nor perpendicular) to the axis.

For each of the one or more blades, the cross-section may be defined by a plurality of sides, one or more of the plurality of sides being perpendicular to both the axial and radial directions and less or equal to 20% of a thickness of a blade.

In a further aspect, there is provided a turbomolecular pump comprising one or more turbomolecular pump bladed discs, the one or more turbomolecular pump bladed discs being in accordance with any of the preceding aspects.

The one or more turbomolecular pump bladed discs may be rotor discs or stator discs.

In a further aspect, there is provided a method of manufacturing a turbomolecular pump bladed disc, the turbomolecular pump bladed disc being in accordance with any preceding aspect. The method comprises: providing a disc; and machining the disc to produce the turbomolecular pump bladed disc.

The machining may comprise applying, a blade of the disc, a first radial cut, wherein, when the blade is viewed along a radial direction, the first radial cut extends in a substantially straight line from a foremost vertex of the blade to an intermediate point along a rearmost side of the blade.

The machining may comprise applying, to the blade, a second radial cut, wherein, when viewed along the radial direction, the second radial cut extends in a substantially straight line from an intermediate point along a leading side of the blade to a rearmost vertex of the blade.

The first radial cut and the second radial cut may be performed simultaneously or at least overlapping to some extent temporally.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF DRAWINGS

FIG. 1 is a schematic illustration (not to scale) showing a turbomolecular pump;

FIG. 2 is a schematic illustration (not to scale) showing an example conventional rotor disc of a turbomolecular pump;

FIG. 3 is a schematic illustration (not to scale) showing a cross-section through a rotor blade of the conventional rotor disc;

FIG. 4 is a schematic illustration (not to scale) showing an embodiment of a rotor disc of a turbomolecular pump;

FIG. 5 is a schematic illustration (not to scale) showing a cross-section through the rotor blade of FIG. 4;

FIG. 6 is a schematic illustration (not to scale) showing a cross-section through a further rotor blade;

FIG. 7 is a schematic illustration (not to scale) showing a cross-section through a yet further rotor blade;

FIG. 8 is a process flow chart showing certain steps of a method of manufacturing a turbomolecular pump bladed disc; and

FIGS. 9 to 11 are schematic illustrations illustrating various machining operations that may be performed during the method of FIG. 8.

### DETAILED DESCRIPTION

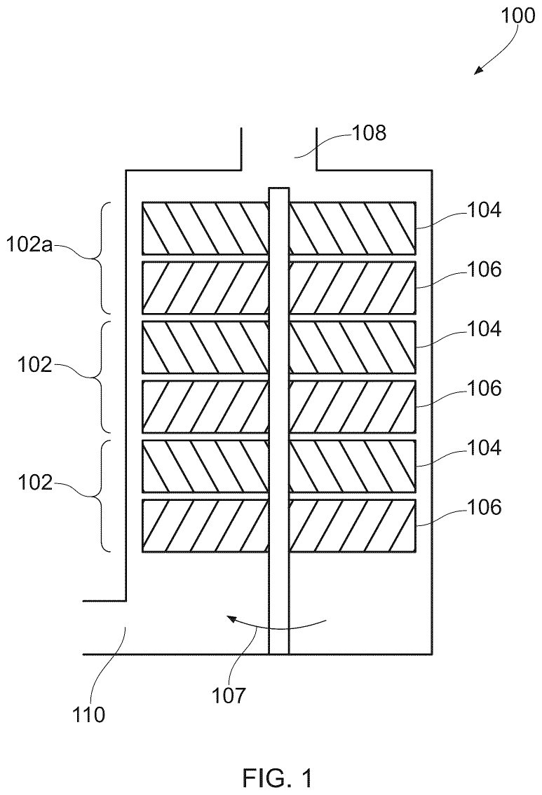

FIG. 1 is a schematic illustration (not to scale) showing a turbomolecular pump 100.

The turbomolecular pump 100 comprises a plurality of stages 102. Each stage comprises a respective pair of bladed discs, specifically a rotor disc 104 and a stator disc 106.

In operation, the rotor discs 104 are rotated at high-speed relative to the stator discs 106, as indicated in FIG. 1 by a solid arrow and the reference numeral 107. In operation, the upper stage 102a of the turbomolecular pump 100 receives gas from a location external to the turbomolecular pump 100 (e.g. a chamber from which it is desired to pump gas) via an inlet 108 of the turbomolecular pump 100. As the gas molecules enter through the inlet 108, the blades of the rotating rotor disc 104 of the upper stage 102 impact the gas molecules, pushing the gas molecules into the gas transfer spaces between the blades of the stator disc 106 of the upper stage. In this way, the gas molecules are transferred to the next stage 102 where the gas molecules collide with the blades of the rotating rotor disc 104 of that stage, and the process is continued until the gas molecules are forced out of an outlet 110 of the turbomolecular pump 100.

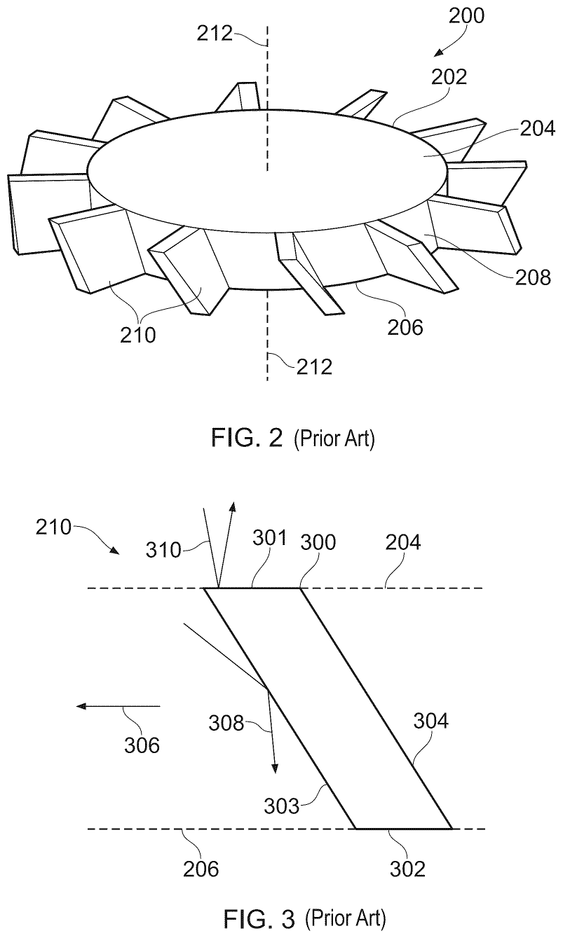

FIG. 2 is a schematic illustration (not to scale) showing an example conventional rotor disc 200 of a turbomolecular pump. The conventional rotor disc 200 may be used in the turbomolecular pump 100 described in more detail above with reference to FIG. 1.

In this example, the conventional rotor disc 200 comprises a substantially cylindrical central hub 202 having an upper first surface 204, a lower second surface 206 opposite to the first surface 204, and a peripheral side surface 208 disposed between the first surface 204 and the second surface 206. The conventional rotor disc 200 further comprises a plurality of rotor blades 210 extending radially outwards from the peripheral side surface 208 of the central hub 202.

The conventional rotor disc 200 is configured to, in operation, be rotated about its central axis 212. The axis 212 defines an axial direction.

FIG. 3 is a schematic illustration (not to scale) showing a cross-section 300 through a rotor blade 210 of the conventional rotor disc 200. The cross-section 300 shown in FIG. 3 is an intersection of the rotor blade 210 with a plane that is perpendicular to the radial direction along which that rotor blade 210 extends.

In this example, the rotor blades 210 are substantially identical to one another.

In this example, the shape of the cross-section 300 of the rotor blade 210 is substantially that of a parallelogram. The cross-section 300 has four sides, namely a first side 301, a second side 302, a third side 303, and a fourth side 304.

The first side 301 is an upper side of the rotor blade 210. In this example, the first side 302 is substantially parallel with the upper first surface 204 of the central hub 202 of the conventional rotor disc 200.

The second side 302 is a lower side of the rotor blade 210. In this example, the second side 302 is opposite to the first side 301. The second side 302 is substantially parallel with the lower second surface 206 of the central hub 202 of the conventional rotor disc 200.

The third side 303 is a leading or front surface of the rotor blade 210 with respect to the direction of rotation of the conventional rotor disc 200 (said direction of rotation being illustrated in FIG. 3 by an arrow and the reference numeral 306). The third side 303 is disposed between the first and second sides 301, 302.

The fourth side 304 is a trailing or rear surface of the rotor blade 210 with respect to the direction of rotation 306 of the conventional rotor disc 200. The fourth side 304 is opposite to the third side 303. The fourth side 304 is disposed between the first and second sides 301, 302.

In this example, when the conventional rotor disc 200 is implemented in a turbomolecular pump and rotated about its axis 212, gas molecules entering the spaces between the rotor blades 210 are preferentially impacted by the third sides 303 (i.e. the front surface) of the rotor blades 210. Because the third sides 303 of the rotor blades 210 subtend acute angles with the direction of rotation, i.e. they are angled or face downwards, most of the gas molecules are directed or scattered downwards towards the cooperating stator disc 106 of the pump stage 102. Such motion of molecules is indicated in FIG. 3 by a solid arrow and the reference numeral 308.

The present inventors have realised, however, that gas molecules that impact the first sides 301 (i.e. the upper surfaces) of the rotor blades tend to be reflected, i.e. reflected upwards, in a direction opposite to the desired direction of flow of the gas. Such motion of molecules is indicated in FIG. 3 by a solid arrow and the reference numeral 310. Thus, pumping efficiency tends to be reduced.

What will now be described are embodiments of turbomolecular pump bladed discs, i.e. rotor discs and/or stators discs, that tend to reduce or eliminate the unwanted reflection of gas molecules in the direction opposite to the desired direction of the gas.

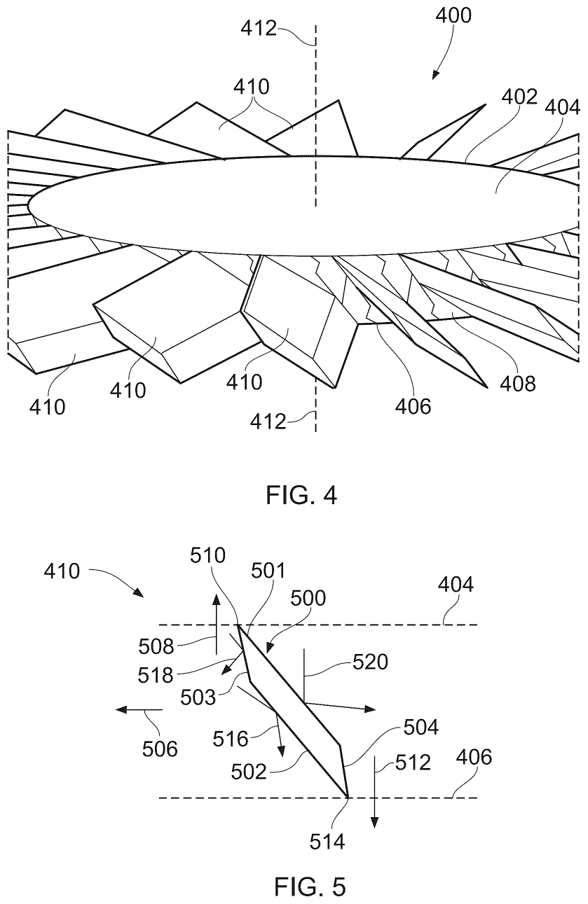

FIG. 4 is a schematic illustration (not to scale) showing an embodiment of a rotor disc 400 of a turbomolecular pump. The rotor disc 400 may be used in the turbomolecular pump 100 described in more detail above with reference to FIG. 1.

In this example, the rotor disc 400 comprises a substantially cylindrical central hub 402 having an upper first surface 404, a lower second surface 406 opposite to the first surface 404, and a peripheral side surface 408 disposed between the first surface 404 and the second surface 406. The rotor disc 400 further comprises a plurality of rotor blades 410 extending radially outwards from the peripheral side surface 408 of the central hub 402.

In this embodiment, the rotor blades 410 are substantially identical to one another.

The rotor disc 400 is configured to, in operation, be rotated about its central axis 412. The axis 412 defines an axial direction.

FIG. 5 is a schematic illustration (not to scale) showing a cross-section 500 through a rotor blade 410 of the rotor disc 400. The cross-section 500 shown in FIG. 5 is an intersection of the rotor blade 410 with a plane that is perpendicular to the radial direction along which that rotor blade 410 extends.

In this example, the shape of the cross-section 500 of the rotor blade 410 is substantially that of a parallelogram. The cross-section 500 has four sides, namely a first side 501, a second side 502, a third side 503, and a fourth side 504.

The first side 501 is an upper side of the rotor blade 410. In this example, the first side 302 is oblique to the upper first surface 404 of the central hub 402 of the rotor disc 400.

The second side 502 is a lower side of the rotor blade 410. In this example, the second side 502 is opposite to the first side 501. The second side 502 is oblique to the lower second surface 406 of the central hub 402 of the rotor disc 400.

The third side 503 is a leading or front surface of the rotor blade 410 with respect to the direction of rotation of the rotor disc 400 (said direction of rotation being illustrated in FIG. 5 by an arrow and the reference numeral 506). The third side 503 is disposed between the first and second sides 501, 502.

The fourth side 504 is a trailing or rear surface of the rotor blade 410 with respect to the direction of rotation 506 of the rotor disc 400. The fourth side 504 is opposite to the third side 503. The fourth side 504 is disposed between the first and second sides 501, 502.

In this embodiment, the second side 502 subtends a smaller, i.e. shallower angle, with the direction of rotation 506 than does the third side 503.

In this embodiment, all of the sides 501-504 of the cross-section 500 of the rotor blade 410 are oblique to the first and second surfaces 404, 406 of the rotor disc 400.

In this embodiment, all of the sides 501-504 of the cross-section 500 of the rotor blade 410 are oblique to the axis 412 of the rotor disc 400.

In this embodiment, the cross-section 500 of the rotor blade 410 tapers inwards in a first direction 508. The first direction 508 is an upwards direction that is parallel with the axial direction defined by the axis 412. The first direction 508 is substantially perpendicular to the direction of rotation 506.

In other words, the width or thickness of the cross-section 500 of the rotor blade 410 reduces or decreases along the first direction 508. The width or thickness of the cross-section 500 of the rotor blade 410 may be a dimension of the cross-section 500 of the rotor blade 410 that is perpendicular to the first direction 510 and in the plane of the cross-section.

In this embodiment, the cross-section 500 of the rotor blade 410 tapers to a first point 510 in the first direction 508. In this embodiment, the first point 510 is the furthest point of the cross-section 500 in the first direction 508.

In this embodiment, the cross-section 500 of the rotor blade 410 tapers inwards in a second direction 512. The second direction 512 is a downwards direction that is parallel with the axial direction defined by the axis 412. The second direction 512 is opposite to the first direction 508. The second direction 512 is substantially perpendicular to the direction of rotation 506. More specifically, in this embodiment, the cross-section 500 of the rotor blade 410 tapers to a second point 514 in the second direction 512. In this embodiment, the second point 514 is the furthest point of the cross-section 500 in the second direction 512.

In this embodiment, when the rotor disc 400 is implemented in a turbomolecular pump, such as the turbomolecular pump 100 described in more detail earlier above with reference to FIG. 1, and rotated about its axis 412, gas molecules entering the spaces between the rotor blades 410 are preferentially impacted by the third sides 503 (i.e. the front surface) of the rotor blades 410, and also by the second sides 502 (i.e. lower side) of the rotor blades 410. In this embodiment, both the second and third sides 502, 503 of the rotor blades 410 subtend acute angles with the direction of rotation 506. In other words, both the second and third sides 502, 503 of the rotor blades 410 are angled or face downwards. Thus, the gas molecules impacted by the second and/or third sides 502, 503 of the rotor blades 410 tends to be directed or scattered downwards towards the cooperating stator disc of the pump stage. The motion of molecules that are impacted by the second sides 502 is indicated in FIG. 5 by a solid arrow and the reference numeral 516, and the motion of molecules that are impacted by the third sides 503 is indicated in FIG. 5 by a solid arrows and the reference numeral 518.

In this embodiment, gas molecules that impact the first sides 501 (i.e. the upper surfaces) of the rotor blades 410 tend to be directed or scattered in a direction opposite to the direction of rotation 506. That is to say, gas molecules that impact the first sides 501 tend to be directed in a direction towards the following rotor blade 410 on the rotor disc 400. In particular, the gas molecules tend to be directed such that impact with the second and/or third side 502, 503 of the subsequent rotor blade 410 on the rotor disc 410, and are thereby directed in a downward direction. The motion of molecules that are impacted by the first sides 501 is indicated in FIG. 5 by a solid arrow and the reference numeral 520.

The rotor blade 410 comprises no upper surface that is parallel with the upper first surface 404 of the central hub 402. In particular, the upper facing surfaces of the rotor blade 410, i.e. the first surfaces 501, subtend an obtuse angle with the direction of rotation 506.

Thus, advantageously, reflection of gas molecules in the upwards direction tends to be reduced or eliminated. This tends to increase pumping efficiency.

The length of the rotor blade 410 is a dimension from a root or proximal end of the rotor blade 410 where the rotor blade 410 joins the central hub 402, to a tip or distal end of the rotor blade 410 opposite to the root or proximal end. The length of the rotor blade 410 is parallel with a radial direction along which the rotor blade 410 extends from the central hub 402.

In the above embodiment, the cross-section 500 of the rotor blade 410 is substantially the same along an entirety of the length of the rotor blade 410. Thus, the cross-section shown in FIG. 5 may be that of the rotor blade 410 anywhere along the length of the rotor blade. For example, the cross-section 500 shown in FIG. 5 may be that of the rotor blade 410 at or proximate to the tip of the rotor blade 410. Also, the cross-section 500 shown in FIG. 5 may be that of the rotor blade 410 at or proximate to the root of the rotor blade 410. However, in other embodiments, the cross-section of the rotor blade is not substantially the same along an entirety of the length of the rotor blade. For example, in some embodiments, a size, shape, and/or orientation of the cross-section of a blade at or proximate to a root of the blade is different to a size, shape, and/or orientation of the cross-section of the blade at or proximate to a tip of the blade. In some embodiments, the blade is twisted along its length about its respective radial direction. In some embodiments, the second side 502 and/or the third side 503 subtend a smaller, i.e. shallower angle, with respect to the direction of rotation 506 at or proximate to the tip of the rotor blade 410 than they do at or proximate to the root of the rotor blade 410. Preferably, the cross-section 500 of the rotor blade 410 tapers inwards in the first direction 508 along at least a majority of a length of the rotor blade 410. More preferably, the cross-section 500 tapers inwards in the first direction 508 along the entirety of the length of the rotor blade 410. The cross-section 500 may taper in the second direction 512 along all or part of the length of the rotor blade 410.

In the above embodiments, all of the sides of the cross-section of the rotor blade are oblique to the first and second surfaces of the rotor disc. However, in other embodiments, one or more of the sides of the cross-section of the rotor blade are not oblique to the first and second surfaces of the rotor disc. For example, one or more of the sides of the cross-section of the rotor blade may be substantially parallel with to the first and second surfaces of the rotor disc, i.e. substantially perpendicular to the axis.

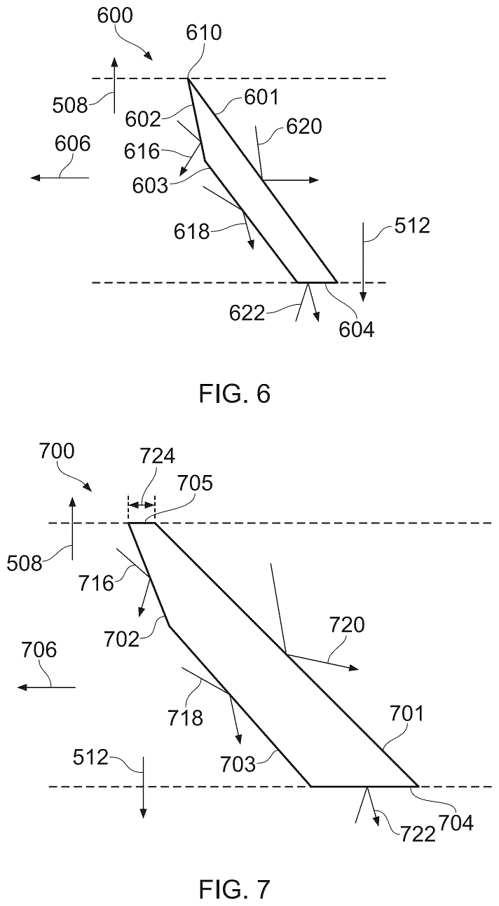

FIG. 6 is a schematic illustration (not to scale) showing a cross-section 600 through a further embodiment of a rotor blade. This rotor blade extends radially from the central hub 402. The cross-section 600 shown in FIG. 6 is an intersection of the rotor blade with a plane that is perpendicular to the radial direction along which that rotor blade extends.

In this example, the shape of the cross-section 600 of the rotor blade 410 is substantially that of a trapezium. The cross-section 600 has four sides, namely a first side 601, a second side 602, a third side 603, and a fourth side 604.

The first side 601 is a trailing or rear surface of the rotor blade with respect to the direction of rotation 606 of the rotor disc. The first side 601 is oblique to the upper first surface 404 of the central hub 402 of the rotor disc. The first side 601 is disposed between the second and fourth sides 602, 604.

The second side 602 is a first leading or front surface of the rotor blade with respect to the direction of rotation 606. The second side 602 is disposed between the first and third sides 601, 603.

The third side 603 is a second leading or front surface of the rotor blade with respect to the direction of rotation 606. The third side 603 is disposed between the second and fourth sides 602, 604.

The second and third sides 602, 603 are disposed opposite to the first side 601. The second and third sides 602, 603 are oblique to the first and second surfaces 404, 406 of the central hub 402 of the rotor disc.

The fourth side 604 is a lower side of the rotor blade. The fourth side 604 is substantially parallel to the lower second surface 406 of the central hub 402 of the rotor disc.

In this embodiment, the cross-section 600 of the rotor blade tapers inwards in the first direction 508. More specifically, in this embodiment, the cross-section 600 tapers to a first point 610 in the first direction 508. In this embodiment, the first point 610 is the furthest point of the cross-section 600 in the first direction 508.

In this embodiment, the cross-section 600 of the rotor blade does not taper inwards in the second direction 512. More specifically, the lowermost portion of the rotor blade does not taper in the second direction 512 and the width of the lowermost portion of the rotor blade (i.e., the distance between the opposing first and third sides 601, 603 in a direction parallel with the direction of rotation 606) remains substantially constant in the second direction 512. In this embodiment, the fourth side 604 is the furthest point of the cross-section 600 in the second direction 512. In some embodiments, the cross-section 600 of the rotor blade may taper outwards, or may taper inwards to some extent, in the second direction 512.

In this embodiment, when a rotor disc comprising blades having the cross-section 600 shown in FIG. 6 is implemented in a turbomolecular pump, such as the turbomolecular pump 100 described in more detail earlier above with reference to FIG. 1, and rotated about its axis, gas molecules entering the spaces between the rotor blades are preferentially impacted by the second sides 602 and the third sides 603 (i.e. the front surfaces) of the rotor blades. In this embodiment, both the second and third sides 602, 603 of the rotor blades subtend acute angles with the direction of rotation 606. In other words, both the second and third sides 602, 603 of the rotor blades are angled or face downwards. Thus, the gas molecules impacted by the second and/or third sides 602, 603 of the rotor blades tend to be directed or scattered downwards towards the cooperating stator disc of the pump stage. The motion of molecules that are impacted by the second sides 602 is indicated in FIG. 6 by a solid arrow and the reference numeral 616, and the motion of molecules that are impacted by the third sides 603 is indicated in FIG. 6 by a solid arrow and the reference numeral 618.

In this embodiment, gas molecules that impact the first sides 601 (i.e. the trailing surfaces) of the rotor blades tend to be directed or scattered in a direction opposite to the direction of rotation 606 towards the following rotor blade. In particular, the gas molecules tend to be directed such that they impact with the second and/or third side 602, 603 of the subsequent rotor blade on the rotor disc, and are thereby directed in a downward direction. The motion of molecules that are impacted by the first sides 601 is indicated in FIG. 6 by a solid arrow and the reference numeral 620.

Similarly to the embodiment of FIG. 4, the rotor blade comprises no upper surface that is parallel with the upper first surface 404 of the central hub 402. Thus, advantageously, reflection of gas molecules in the upwards direction tends to be reduced or eliminated. This tends to increase pumping efficiency.

Furthermore, in this embodiment, the rotor blade comprises a lower surface, corresponding to the fourth side 604, that is parallel with the lower second surface 406 of the central hub 402. Thus, advantageously, gas molecules that are travelling in an undesirable upward direction within the turbomolecular pump tend to be reflected back downwards, such that they travel in the desired downward direction. This tends to increase pumping efficiency. This reflection of upwardly travelling gas molecules from the fourth side 604 is indicated in FIG. 6 by a solid arrow and the reference numeral 622.

FIG. 7 is a schematic illustration (not to scale) showing a cross-section 700 through a yet further embodiment of a rotor blade. This rotor blade extends radially from the central hub 402. The cross-section 700 shown in FIG. 7 is an intersection of the rotor blade with a plane that is perpendicular to the radial direction along which that rotor blade extends.

In this example, the shape of the cross-section 700 of the rotor blade is substantially that of a pentagon, e.g. an irregular pentagon. The cross-section 700 has five sides, namely a first side 701, a second side 702, a third side 703, a fourth side 704, and a fifth side 705.

The first side 701 is a trailing or rear surface of the rotor blade with respect to the direction of rotation 606 of the rotor disc. The first side 701 is oblique to the upper first surface 404 of the central hub 402 of the rotor disc. The first side 701 is disposed between the fifth and fourth sides 705, 704.

The second side 702 is a first leading or front surface of the rotor blade with respect to the direction of rotation 706. The second side 702 is disposed between the fifth and third sides 705, 703.

The third side 703 is a second leading or front surface of the rotor blade with respect to the direction of rotation 706. The third side 703 is disposed between the second and fourth sides 702, 704.

The second and third sides 702, 703 are disposed opposite to the first side 701. The second and third sides 702, 703 are oblique to the first and second surfaces 404, 406 of the central hub 402 of the rotor disc.

The fourth side 704 is a lower side of the rotor blade. The fourth side 704 is substantially parallel to the lower second surface 406 of the central hub 402 of the rotor disc. The fourth side 704 is disposed between the third and first sides 703, 701.

The fifth side 705 is an upper side of the rotor blade. The fifth side 705 is substantially parallel to the upper first surface 404 of the central hub 402 of the rotor disc. The fifth side 705 is disposed between the first and second sides 701, 702.

In this embodiment, the cross-section 600 of the rotor blade tapers inwards in the first direction 508. However, unlike in some other embodiments, the cross-section 600 does not taper inwards to a point in the first direction 508. Instead, in this embodiment, the cross-section 600 tapers inwards in the first direction 508 to form the fifth side 705. In this embodiment, the fifth side 705 defines the furthest point of the cross-section 700 in the first direction 508.

In this embodiment, the cross-section 700 of the rotor blade does not taper inwards in the second direction 512. The cross-section 700 of the rotor blade tapers outwards in the second direction 512. However, in other embodiments the cross-section 700 does taper inwards or does not taper in the second direction 512. In this embodiment, the fourth side 704 is the furthest point of the cross-section 600 in the second direction 512.

In this embodiment, when a rotor disc comprising blade having the cross-section 700 shown in FIG. 7 is implemented in a turbomolecular pump, such as the turbomolecular pump 100 described in more detail earlier above with reference to FIG. 1, and rotated about its axis, gas molecules entering the spaces between the rotor blades are preferentially impacted by the second sides 702 and the third sides 703 (i.e. the front surfaces) of the rotor blades. In this embodiment, both the second and third sides 702, 703 of the rotor blades subtend acute angles with the direction of rotation 706. In other words, both the second and third sides 702, 703 of the rotor blades are angled or face downwards. Thus, the gas molecules impacted by the second and/or third sides 702, 703 of the rotor blades tend to be directed or scattered downwards towards the cooperating stator disc of the pump stage. The motion of molecules that are impacted by the second sides 702 is indicated in FIG. 7 by a solid arrow and the reference numeral 716, and the motion of molecules that are impacted by the third sides 703 is indicated in FIG. 7 by a solid arrow and the reference numeral 718.

In this embodiment, gas molecules that impact the first sides 701 (i.e. the trailing surfaces) of the rotor blades tend to be directed or scattered in a direction opposite to the direction of rotation 706 towards the following rotor blade. In particular, the gas molecules tend to be directed such that they impact with the second and/or third side 702, 703 of the subsequent rotor blade on the rotor disc, and are thereby directed in a downward direction. The motion of molecules that are impacted by the first sides 701 is indicated in FIG. 7 by a solid arrow and the reference numeral 720.

In this embodiment, the rotor blade comprises a lower surface, corresponding to the fourth side 704, that is parallel with the lower second surface 406 of the central hub 402. Thus, advantageously, gas molecules that are travelling in an undesirable upward direction within the turbomolecular pump tend to be reflected back downwards, such that they travel in the desired downward direction. This tends to increase pumping efficiency. This reflection of upwardly travelling gas molecules from the fourth side 704 is indicated in FIG. 7 by a solid arrow and the reference numeral 722.

In this embodiment, the rotor blade comprises upper surface, corresponding to the fifth side 705, that is parallel with the upper first surface 404 of the central hub 402. In order to reduce or limit reflection of incident gas molecules in the upwards direction, the dimensions of the upper surface of the rotor blade are limited. In particular, in this embodiment, the size of the fifth side 705, which is indicated in FIG. 7 by a double-headed arrow and the reference numeral 724, is limited to be 5 mm or less. More preferably, the size of the fifth side 705 is less than or equal to 4 mm. More preferably, the size of the fifth side 705 is less than or equal to 3 mm. More preferably, the size of the fifth side 705 is less than or equal to 2 mm. More preferably, the size of the fifth side 705 is less than or equal to 1 mm. In this embodiment, the size 724 of the fifth side 705 may be less than or equal to 20% of a thickness of the blade. This thickness of the blade may be a, e.g. perpendicular, distance between the first and third sides 701, 703. The first and third sides 701, 703 may be parallel to each other. The size 724 of the fifth side 705 may be between 10% and 20% of a thickness of the blade. The size 724 of the fifth side 705 may be less than or equal to 10% of a thickness of the blade.

In the above embodiments, the turbomolecular pump bladed disc is a rotor disc. However, in other embodiments, the turbomolecular pump bladed disc is a stator disc.

In the above embodiments, the rotor blades of the rotor disc are substantially identical to one another. However, in other embodiments, one or more of the blades is different to one or more other blades of the disc. For example, in some embodiments, a turbomolecular pump bladed disc may comprise blades selected from multiple different embodiments herein described.

What will now be described is a method of manufacture of an embodiment of turbomolecular pump bladed disc.

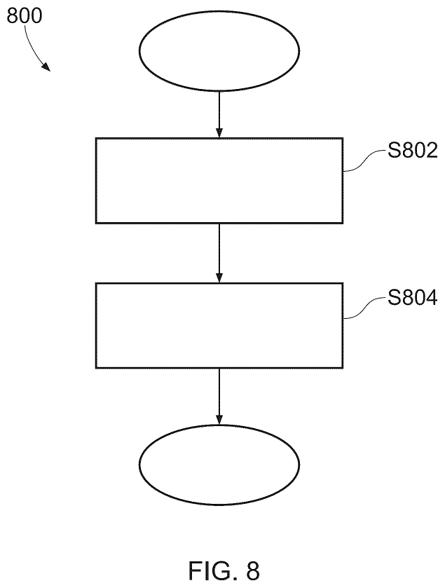

FIG. 8 is a process flow chart showing certain steps of a method 800 of manufacturing a turbomolecular pump bladed disc in accordance with an embodiment.

It should be noted that certain of the process steps depicted in the flowchart of FIG. 8 and described below may be omitted or such process steps may be performed in differing order to that presented above/below and shown in FIG. 8. Furthermore, although all the process steps have, for convenience and ease of understanding, been depicted as discrete temporally-sequential steps, nevertheless some of the process steps may in fact be performed simultaneously or at least overlapping to some extent temporally.

At step s802, an initial turbomolecular pump bladed disc is provided. In this embodiment, the initial turbomolecular pump bladed disc is a conventional turbomolecular pump bladed disc such as that described in more detail earlier above with reference to FIGS. 2 and 3.

Provision of the initial turbomolecular pump bladed disc may be performed in any appropriate way. For example, the initial turbomolecular pump bladed disc may be formed using any method known to the skilled person from an appropriate blank. The blank may be a disc or cylinder of metal, or an annular metal sheet or plate. In some embodiments, passages or spaces between blades may be milled out of the blank, or the blank may be subdivided at its periphery by radial cuts along the radial length of the blades. In some embodiments, the separate blades may be twisted through a desired angle to the plane of the blank during the same or a subsequent operation.

At step s804, the blades of the initial turbomolecular pump bladed disc, hereinafter referred to as “initial blades”, are machined such that the turbomolecular pump bladed disc is in accordance with any embodiment herein described.

As an example, one or more initial blades are machined such that their respective cross-sections, taken in planes perpendicular to the respective radial directions, are substantially the same as that described above with reference to FIG. 5.

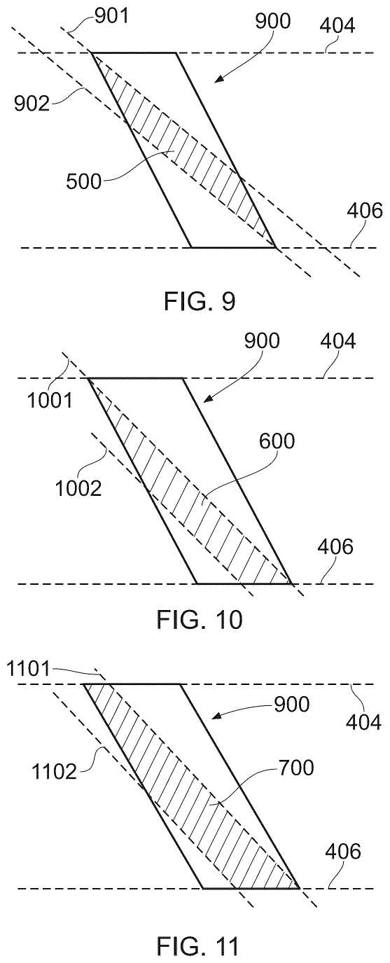

FIG. 9 is a schematic illustration (not to scale) showing a cross-section 900 through an initial blade. The cross-section 900 shown in FIG. 9 is an intersection of the initial blade with a plane that is perpendicular to the radial direction along which that initial blade extends.

FIG. 9 illustrates how the initial blade may be machined such that its cross-section 900 is made to be substantially the same as that described above with reference to FIG. 5 (this cross-sectional shape is indicated in FIG. 9 by hatching and the reference numeral 500). In this embodiment, the initial blade is machined by applying a first radial cut 901 and a second radial cut 902. Each radial cut 901, 902 extends along a length of the initial blade in the radial direction. When viewed along the radial direction, as in FIG. 9, the first radial cut 901 extends in a substantially straight line from a foremost vertex of the cross-section 900 to an intermediate point along a rearmost side of the cross-section 900. When viewed along the radial direction, as in FIG. 9, the second radial cut 902 extends in a substantially straight line from an intermediate point along a leading side of the cross-section 900 to a rearmost vertex of the cross-section 900.

In this embodiment, the first radial cut 901 and the second radial cut 902 are substantially parallel.

Preferably, the first radial cut 901 and the second radial cut 902 are performed simultaneously or at least overlapping to some extent temporally. More preferably, the first radial cut 901 and the second radial cut 902 are performed simultaneously. Performing the first radial cut 901 and the second radial cut 902 simultaneously or at least overlapping to some extent temporally advantageously tends to apply equal pressure on opposite sides of the blade during cutting, which tends to reduce damage to or stresses on the blade.

As another example, one or more initial blades are machined such that their respective cross-sections, taken in planes perpendicular to the respective radial directions, are substantially the same as that described above with reference to FIG. 6.

FIG. 10 is a schematic illustration (not to scale) showing a cross-section 900 through an initial blade. The cross-section 900 shown in FIG. 9 is an intersection of the initial blade with a plane that is perpendicular to the radial direction along which that initial blade extends.

FIG. 10 illustrates how the initial blade may be machined such that its cross-section 900 is made to be substantially the same as that described above with reference to FIG. 6 (this cross-sectional shape is indicated in FIG. 9 by hatching and the reference numeral 600). In this embodiment, the initial blade is machined by applying a third radial cut 1001 and a fourth radial cut 1002. Each radial cut 1001, 1002 extends along a length of the initial blade in the radial direction. When viewed along the radial direction, as in FIG. 10, the third radial cut 1001 extends in a substantially straight line from a foremost vertex of the cross-section 900 to a rearmost vertex of the cross-section 900. When viewed along the radial direction, as in FIG. 10, the fourth radial cut 1002 extends in a substantially straight line from an intermediate point along a leading side of the cross-section 900 to an intermediate point along a lower side of the cross-section 900.

The third radial cut 1001 and the fourth radial cut 1002 may be substantially parallel.

Preferably, the third radial cut 1001 and the fourth radial cut 1002 are performed simultaneously or at least overlapping to some extent temporally. More preferably, the third radial cut 1001 and the fourth radial cut 1002 are performed simultaneously. Performing the third radial cut 1001 and the fourth radial cut 1002 simultaneously or at least overlapping to some extent temporally advantageously tends to apply equal pressure on opposite sides of the blade during cutting, which tends to reduce damage to or stresses on the blade.

As another example, one or more initial blades are machined such that their respective cross-sections, taken in planes perpendicular to the respective radial directions, are substantially the same as that described above with reference to FIG. 7.

FIG. 11 is a schematic illustration (not to scale) showing a cross-section 900 through an initial blade. The cross-section 900 shown in FIG. 11 is an intersection of the initial blade with a plane that is perpendicular to the radial direction along which that initial blade extends.

FIG. 11 illustrates how the initial blade may be machined such that its cross-section 900 is made to be substantially the same as that described above with reference to FIG. 7 (this cross-sectional shape is indicated in FIG. 9 by hatching and the reference numeral 700). In this embodiment, the initial blade is machined by applying a fifth radial cut 1101 and a sixth radial cut 1102. Each radial cut 1101, 1102 extends along a length of the initial blade in the radial direction. When viewed along the radial direction, as in FIG. 11, the fifth radial cut 1101 extends in a substantially straight line from an intermediate point along an upper side of the cross-section 900 to a rearmost vertex of the cross-section 900. When viewed along the radial direction, as in FIG. 10, the sixth radial cut 1102 extends in a substantially straight line from an intermediate point along a leading side of the cross-section 900 to an intermediate point along a lower side of the cross-section 900.

The fifth radial cut 1101 and the sixth radial cut 1102 may be substantially parallel.

Preferably, the fifth radial cut 1101 and the sixth radial cut 1102 are performed simultaneously or at least overlapping to some extent temporally. More preferably, the fifth radial cut 1101 and the sixth radial cut 1102 are performed simultaneously. Performing the fifth radial cut 1101 and the sixth radial cut 1102 simultaneously or at least overlapping to some extent temporally advantageously tends to apply equal pressure on opposite sides of the blade during cutting, which tends to reduce damage to or stresses on the blade.

Thus, the method 800 of manufacturing a turbomolecular pump bladed disc is provided.

In the embodiments described above with reference to FIGS. 9-11, each radial cut extends along a length of the initial blade in the radial direction. In some embodiments, the radial cuts made to the initial blade extend along an entirety of the length of the initial blade in the radial direction, thereby to alter the cross-section of the blade along an entirety of the length of that blade. In other embodiments, the radial cuts made to the initial blade do not extend along an entirety of the length of the initial blade in the radial direction, thereby to alter the cross-section of the respective blade along only a part of the length of that blade, e.g. at or proximate a tip portion and not a root portion.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A turbomolecular pump bladed disc, comprising:
a central hub configured to be rotated about an axis, the axis defining an axial direction; and one or more blades radially extending from the central hub; wherein
each of the one or more blades has a cross-section that:
tapers to a first point in a first direction, the first direction being parallel with the axial direction;
tapers to a second point in a second direction, the second direction being parallel with the axial direction and opposite to the first direction; and
is approximately a parallelogram in shape; and
for each of the one or more blades, the cross-section of that blade is an intersection of that blade with a plane perpendicular to a radial direction in which that blade extends from the central hub.

2. (canceled)

3. The turbomolecular pump bladed disc of claim 1, wherein, for each of the one or more blades, the cross-section of that blade is at or proximate to a tip of that blade.

4. The turbomolecular pump bladed disc of claim 1, wherein, for each of the one or more blades, the cross-section tapers to a point in the first direction along at least a majority of a length of the blade, the length of the blade being defined in a direction radially outward from the central hub.

5. The turbomolecular pump bladed disc of claim 4, wherein, for each of the one or more blades, the cross-section tapers to a point in the first direction along an entirety of the length of the blade.

6. The turbomolecular pump bladed disc of claim 1, wherein, for each of the one or more blades, the cross-section tapers to a point in the second direction along at least a majority of a length of the blade, the length of the blade being defined in a direction radially outward from the central hub.

7. The turbomolecular pump bladed disc of claim 6, wherein, for each of the one or more blades, the cross-section tapers to a point in the second direction along an entirety of the length of the blade.

8. The turbomolecular pump bladed disc of claim 1, wherein, for each of the one or more blades, the first point is a furthest point on the blade in the first direction.

9. The turbomolecular pump bladed disc of claim 1, wherein, for each of the one or more blades, the second point is a furthest point on the blade in the second direction.

10. The turbomolecular pump bladed disc of claim 1, wherein, for each of the one or more blades, the cross-section is defined by a plurality of sides, all of said plurality of sides being oblique or parallel to the axial direction.

11. The turbomolecular pump bladed disc of claim 1, wherein, for each of the one or more blades, the cross-section is defined by a plurality of sides, one or more of the plurality of sides being perpendicular to both the axial and radial directions and less or equal to 20% of a thickness of a blade.

12. A turbomolecular pump comprising one or more turbomolecular pump bladed discs, the one or more turbomolecular pump bladed discs being in accordance with claim 1.

13. The turbomolecular pump of claim 12, wherein the one or more turbomolecular pump bladed discs are rotor discs or stator discs.

14. A method of manufacturing a turbomolecular pump bladed disc, the turbomolecular pump bladed disc being in accordance with claim 1, the method comprising:
providing a disc; and
machining the disc to produce the turbomolecular pump bladed disc.

15. The method of claim 14, the machining comprising:
applying, a blade of the disc, a first radial cut, wherein, when the blade is viewed along a radial direction, the first radial cut extends in a substantially straight line from a foremost vertex of the blade to an intermediate point along a rearmost side of the blade; and
applying, to the blade, a second radial cut, wherein, when viewed along the radial direction, the second radial cut extends in a substantially straight line from an intermediate point along a leading side of the blade to a rearmost vertex of the blade.

16. The method of claim 15, wherein the first radial cut and the second radial cut are performed simultaneously or at least overlapping to some extent temporally.
